(19) United States
(12) Patent Application Publication
(10) Pub. No.: US 2012/0163756 A1
(43) Pub. Date: Jun. 28, 2012

(54) OPTICAL FIBER CONNECTOR AND METHOD OF MANUFACTURING THE SAME

(76) Inventors: Yuan-Lin Lee, Changhua (TW); Chia-Jung Chang, Changhua (TW); Wei Shen, Changhua (TW); Yung-Han Yang, Changhua (TW)

(21) Appl. No.: 12/978,511

(22) Filed: Dec. 24, 2010

(51) Int. Cl. G02B 6/36; G02B 6/26

(52) U.S. Cl. 385/76; 264/1.25

(57) ABSTRACT

An optical fiber connector includes an insulating housing, an optical fiber and a transparent hetero substrate. The optical fiber is exposed outside the insulating housing with one end portion molded in the insulating housing. The transparent hetero substrate is molded inside the insulating housing. The transparent hetero substrate is substantially perpendicular to the end portion of the optical fiber and spaced from an end edge of the end portion of the optical fiber. A middle of the transparent hetero substrate is substantially in alignment with the end portion of the optical fiber. The method of manufacturing the above-mentioned optical fiber connector is described hereinafter. Firstly, set an end portion of the optical fiber and a transparent hetero substrate in a mold. Secondly, inject molten materials into the mold. Thirdly, separate the mold and then take out the optical fiber connector from the mold when the mold is cooled.

### BACKGROUND OF THE INVENTION

1. Field of the Invention

The present invention generally relates to an optical fiber connector and a method of manufacturing the same, and more particularly to an optical fiber connector and a method of manufacturing the same capable of mounting an optical fiber in an insulating housing accurately.

2. The Related Art

Generally, an optical fiber is a slim transparent glass fiber or a transparent plastic fiber, and an optical fiber cable includes an optical fiber and a cover surrounding the optical fiber. Referring to FIG. 1, a traditional optical fiber connector 300 used for connecting optical fibers to transmit light signals between transmitter and receiver, includes an insulating housing 6 and an optical fiber 7 of an optical fiber cable (not shown). The insulating housing 6 defines a hole 61 at a bottom thereof. The optical fiber 7 is fastened in the hole 61 by means of injecting adhesives 8 between an outside of the optical fiber 7 and an inside of the hole 61. Fastening the optical fiber 7 in the hole 61 of the insulating housing 6 has following requests. Firstly, a deviation value of a relative position between a center of the optical fiber 7 and a center of the hole 61 must be less than Sum. Contacting area between the optical fiber 7 and the insulating housing 6 mustn't have bubbles or air.

However, in a process of manufacturing the optical fiber connector 300, phenomena of a deviation of the optical fiber 7 assembled in the hole 61, and bubbles or air existence in the contacting area between the optical fiber 7 and the insulating housing 6 are apt to happen. All the phenomena described above will cause a bad connection between the optical fiber 7 and the insulating housing 6, and increase loss of the light signal transmission. Furthermore, The manufacturing procedure needs high-precision assembling equipment, and the cost of assembling the optical fiber 7 to the insulating housing 6 is increased.

### SUMMARY OF THE INVENTION

An object of the present invention is to provide an optical fiber connector and a manufacturing method thereof. The optical fiber connector includes an insulating housing, an optical fiber and a transparent hetero substrate. The optical fiber is exposed outside the insulating housing with one end portion insert molded in the insulating housing. The transparent hetero substrate is insert molded inside the insulating housing. The transparent hetero substrate is substantially perpendicular to the end portion of the optical fiber and spaced from an end edge of the end portion of the optical fiber. A middle of the transparent hetero substrate is substantially in alignment with the end portion of the optical fiber.

The method of manufacturing the above-mentioned optical fiber connector is described hereinafter. Firstly, set an end portion of the optical fiber and a transparent hetero substrate in a mold. Secondly, inject molten materials into the mold. Thirdly, separate the mold and then take out the optical fiber connector from the mold when the mold is cooled.

As described above, the optical fiber being molded in the insulating housing can omit an assembling procedure and omit dropping adhesives on the optical fiber. So that bubbles and air are disappeared, and deviation of relative position of the optical fiber is decreased. Consequently, the optical fiber can be set in the optical fiber connector accurately. A better connection between the optical fiber and the insulating housing is got, and a better light transmission is achieved. Furthermore, the procedures of the manufacturing method described above are simplifier, and the cost of that is lower.

### BRIEF DESCRIPTION OF THE DRAWINGS

The present invention will be apparent to those skilled in the art by reading the following description, with reference to the attached drawings, in which:

FIG. 1 is a sectional view of an optical fiber connector in prior art;

FIG. 2 is a sectional view of a first optical fiber connector of an embodiment of the present invention;

FIG. 3 is a sectional view of a second optical fiber connector according to another embodiment of the present invention;

FIG. 4 is a sectional view showing that an end portion of a first optical fiber is set in a first lower mold of a first mold and molten materials is injected in the first lower mold for molding the first optical fiber connector of FIG. 2, while a first upper mold of the first mold is ready to place on the first lower mold;

FIG. 5 is a sectional view of the first optical fiber connector of FIG. 2 molded in the first mold; and

FIG. 6 is a sectional view showing the first optical fiber connector of FIG. 2 molded in a second mold.

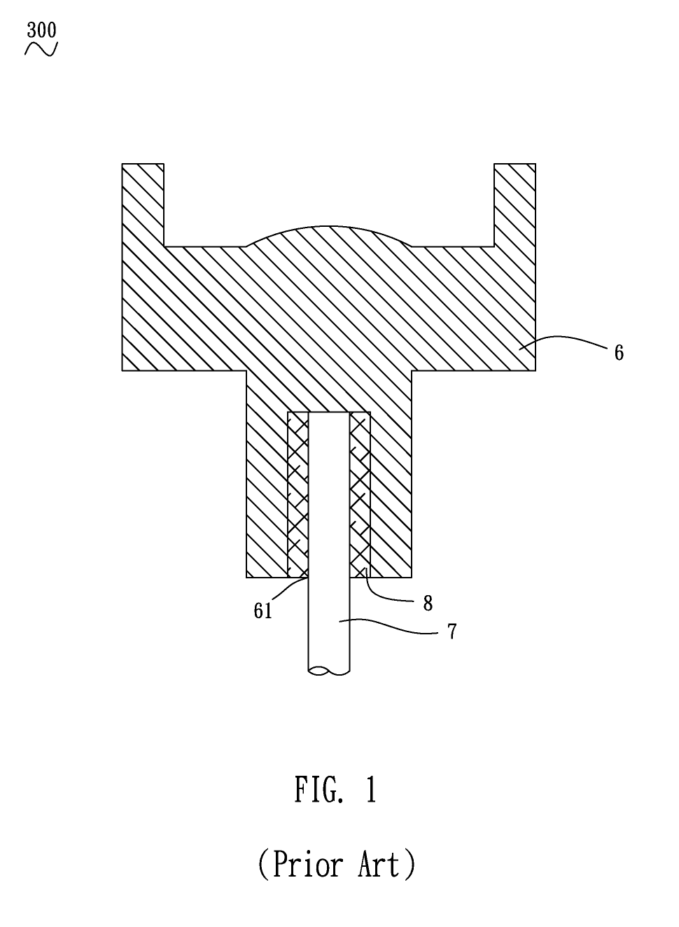

### DETAILED DESCRIPTION OF THE PREFERRED EMBODIMENT

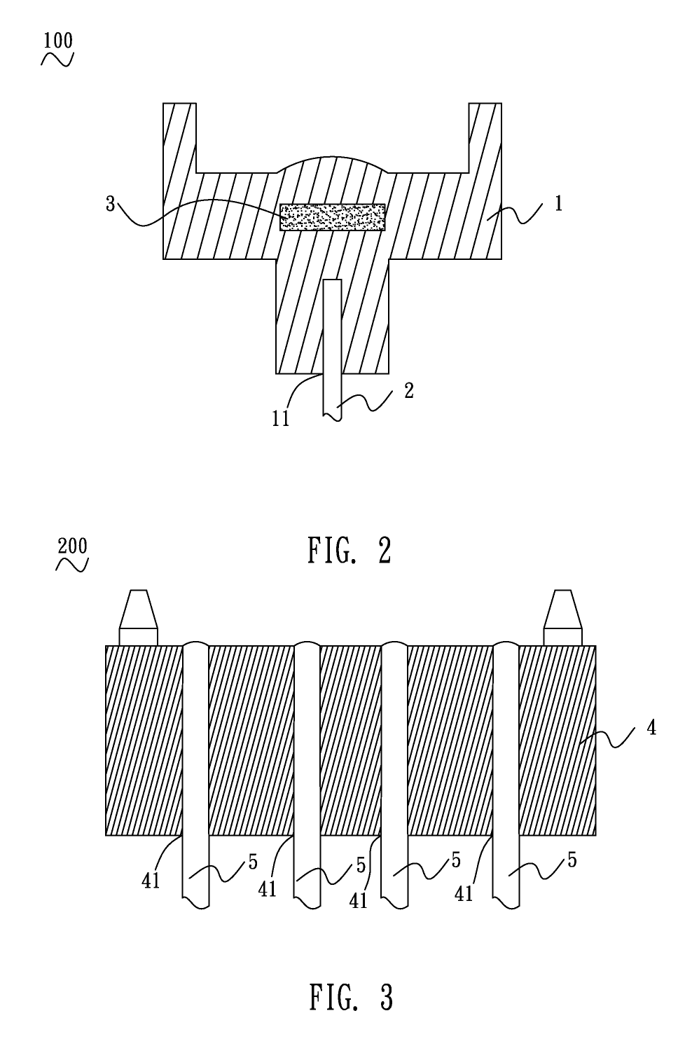

With reference to FIG. 2, a first optical fiber connector 100 according to an embodiment of the present invention includes a first insulating housing 1, a first optical fiber 2 and a transparent hetero substrate 3. The first insulating housing 1 defines a blind-hole 11. The first optical fiber 2 is exposed outside the first insulating housing 1 with one end portion of the first optical fiber 2 being insert molded in the first insulating housing 1 through the blind-hole 11. The transparent hetero substrate 3 is molded inside the first insulating housing 1. The transparent hetero substrate 3 is substantially perpendicular to the end portion of the first optical fiber 2 and spaced from an end edge of the end portion of the first optical fiber 2. A middle of the transparent hetero substrate 3 is substantially in alignment with the end portion of the first optical fiber 2.

Extinction ratio and intensity of light can be improved by means of molding the transparent hetero substrate 3 in the first insulating housing 1. Material of the transparent hetero substrate 3 can be transparent glass or plastic. The surface of the transparent hetero substrate 3 can be a flat surface, a curved surface with effect of light deflection, a fresnel surface or a diffraction pattern surface.

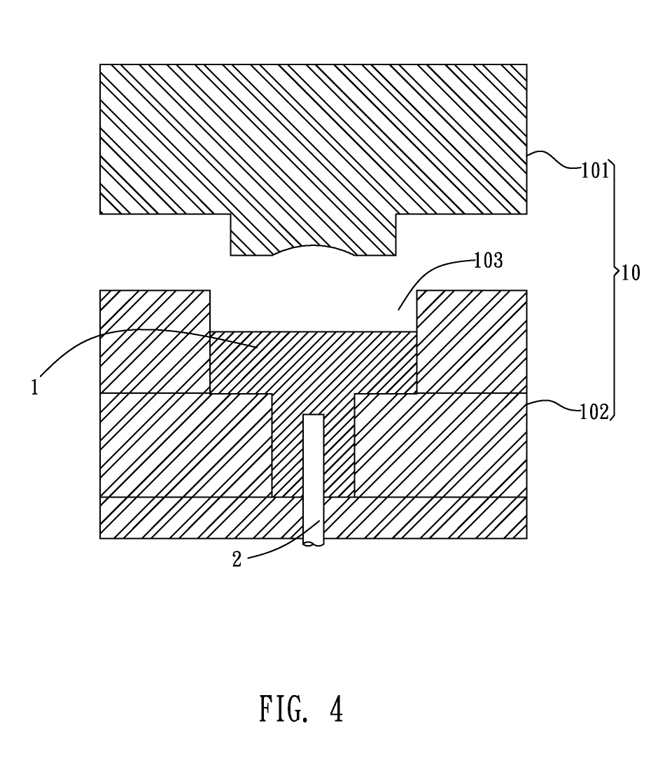

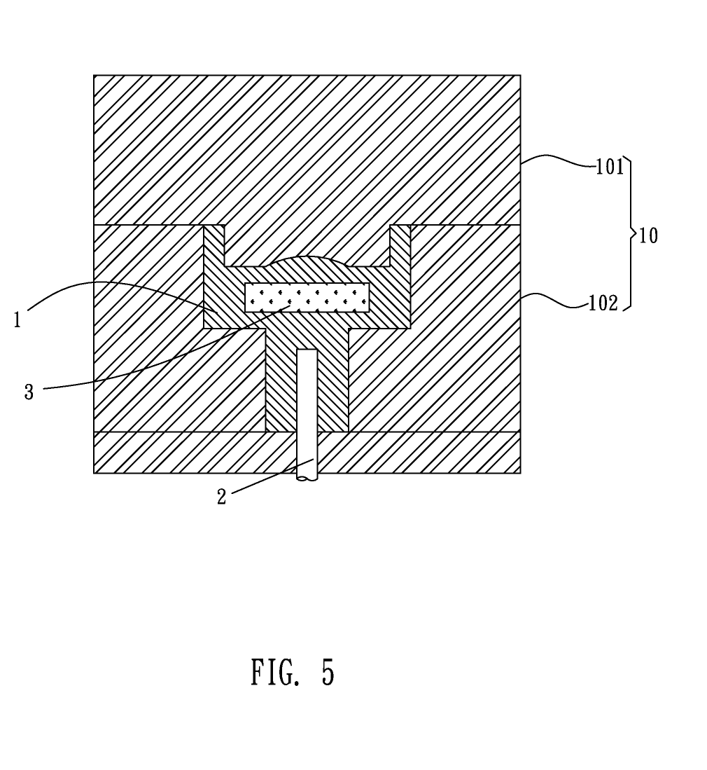

Referring to FIG. 2, FIG. 4 and FIG. 5, specific steps of a first manufacturing method of molding the first optical fiber connector 100 are as following. Firstly, provide a first mold 10 which includes a first upper mold 101 and a first lower mold 102, and a first inner cavity 103 of the first lower mold 102 has a shape as the first optical fiber connector 100. Secondly, set the first optical fiber 2 and the transparent hetero substrate 3 in the first inner cavity 103 of the first lower mold 102. Thirdly, inject molten materials into the first inner cavity 103 of the first lower mold 102. Fourthly, place the first upper mold 101 on the first lower mold 102 to make the first mold 10 filled with the molten materials for molding the first insulating housing 1. Lastly, separate the first mold 10 and then take out the first optical fiber connector 100 from the first mold 10, when the first mold 10 is cooled.

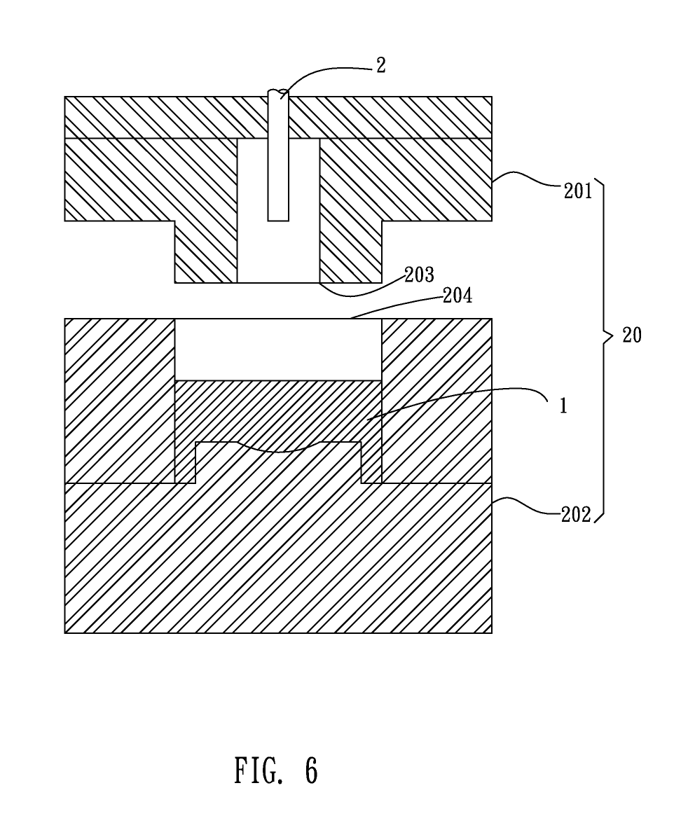

Referring to FIG. 2 and FIG. 6, specific steps of a second manufacturing method of molding the first optical fiber connector 100 are as following. Firstly, provide a second mold 20 which includes a second upper mold 201 and a second lower mold 202, and a second inner cavity 203 of the second upper mold 201 has a shape as a top half of the first optical fiber connector 100 and a third inner cavity 204 of the second lower mold 202 has a bottom half of the first optical fiber connector 100. Secondly, set the first optical fiber 2 and the transparent hetero substrate 3 in the second inner cavity 203 of the second upper mold 201. Thirdly, inject molten materials into the third inner cavity 204 of the second lower mold 202. Fourthly, place the second upper mold 201 on the second lower mold 202 to make the second mold 20 filled with the molten materials for molding the first insulating housing 1. Lastly, separate the second mold 20 and then take out the first optical fiber connector 100 from the second mold 20, when the second mold 20 is cooled.

With reference to FIG. 3, a second optical fiber connector 200 according to another embodiment of the present invention includes a second insulating housing 4 and a plurality of second optical fibers 5. The second insulating housing 4 defines a plurality of through-holes 41. Each of the second optical fibers 5 is exposed outside the second insulating housing 4 with one end portion of the second optical fiber 5 being insert molded in the second insulating housing 4 through the through-holes 41.

With reference to FIGS. 2-3, steps of a manufacturing method of molding the second optical fiber connector 200 can be the same as steps of the first manufacturing method of molding the first optical fiber connector 100 or steps of the second manufacturing method of molding the second optical fiber connector 200.

With reference to FIGS. 2-3, the manufacturing methods of molding the first optical fiber connector 100 and the second optical fiber connector 200 can be injection molding, pouring molding or compressing molding.

As described above, the first optical fiber 2, the second optical fibers 5 being molded in the first insulating housing 1 and the second insulating housing 4, respectively, can omit an assembling procedure and omit dropping adhesives on the first optical fiber 2 and the second optical fibers 5. So that bubbles and air are disappeared, and deviation of relative position of the first optical fiber 2 and the second optical fibers 5 is decreased. Consequently, the first optical fiber 2, the second optical fibers 5 can be set in the first optical fiber connector 100 and the second optical fiber connector 200 accurately. A better connection between the first optical fiber 2 and the first insulating housing 1, the second optical fibers 5 and the second insulating housing 4 is got, and a better light transmission is achieved. Furthermore, the procedures of the first and second manufacturing methods described above are simplifier, and the cost of that is lower.

What is claimed is:

1. An optical fiber connector, comprising:
an insulating housing;
an optical fiber exposed outside the insulating housing, with one end portion insert molded in the insulating housing; and
a transparent hetero substrate insert molded inside the insulating housing, the transparent hetero substrate substantially perpendicular to the end portion of the optical fiber and spaced from an end edge of the end portion of the optical fiber, a middle of the transparent hetero substrate being substantially in alignment with the end portion of the optical fiber.

2. The optical fiber connector as claimed in claim 1, wherein the transparent hetero substrate is a transparent glass.

3. The optical fiber connector as claimed in claim 1, wherein the transparent hetero substrate is a transparent plastic.

4. A method of manufacturing an optical fiber connector as claimed in claim 1, comprising the steps of:
setting an end portion of the optical fiber and a transparent hetero substrate in a mold;
injecting molten materials into the mold; and
separating the mold and then taking out the optical fiber connector from the mold when the mold is cooled.
